(19) United States
(12) Patent Application Publication
(10) Pub. No.: US 2010/0332176 A1
(43) Pub. Date: Dec. 30, 2010

(54) ONLINE SOURCELESS ENERGY CALIBRATION OF MULTIPLE SPECTRAL DETECTORS

(75) Inventor: Loren P. Roberts, Humble, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/820,795

(22) Filed: Jun. 22, 2010

Related U.S. Application Data
(60) Provisional application No. 61/221,152, filed on Jun. 29, 2009.

(51) Int. Cl. G01V 13/00; G01V 5/10

(52) U.S. Cl. 702/104; 250/269.6; 250/252.1

(57) ABSTRACT

An instrument for performing measurements downhole includes: a neutron source; at least one gamma ray detector equipped for discriminating an energy of an incident gamma photon; and an energy calibration target disposed relative to the neutron source and the at least one gamma ray detector. A method and computer program product for calibrating the instrument is provided.

### CROSS-REFERENCE TO RELATED APPLICATIONS AND PRIORITY CLAIM

This application claims the benefit of U.S. Provisional Application Ser. No. 61/221,152, entitled “ONLINE SOURCELESS ENERGY CALIBRATION OF MULTIPLE SPECTRAL DETECTORS”, filed Jun. 29, 2009, under 35 U.S.C. §119(e), which is incorporated herein by reference in its entirety.

### BACKGROUND OF THE INVENTION

1. Field of the Invention

The invention disclosed herein relates to exploration for oil and gas and, in particular, to calibration of gamma detectors in a downhole instrument.

2. Description of the Related Art

In the exploration for oil and gas, it is necessary to drill a wellbore into the Earth. While drilling of the wellbore permits individuals and companies to evaluate sub-surface materials and to extract desired hydrocarbons, many problems are encountered.

For example, use of nuclear instrumentation presents significant safety issues for personnel. That is, aside from the burden of complying with regulation governing the handling of sources of ionizing radiation, workers tasked with performing well logging issues are often asked to handle radioactive sources that can cause detrimental health effects if great care is not taken.

One example is that of a logging instrument that uses a neutron source. Typically, the neutron source is of a considerable strength, and a hazard when considered on its own. However, such instruments also require gamma detection capabilities in order to perform measurements of induced gamma radiation. Accordingly, typical neutron logging instruments incorporate at least one radioactive source that emits gamma radiation, such that energy calibration of the gamma detection capabilities can be performed. The presence of radioactive material creates storage, import and export, transportation, handling and marketing issues.

What are needed are methods and apparatus suited for use in a downhole environment, for performing energy calibration of gamma detection equipment used in conjunction with a neutron source. Preferably, the methods and apparatus should provide for sourceless energy calibrations in either one of a drill string or wireline logging tool.

### BRIEF SUMMARY OF THE INVENTION

In one embodiment, the invention includes an instrument for performing measurements downhole, the instrument including: a neutron source; at least one gamma ray detector equipped for discriminating an energy of an incident gamma photon; and an energy calibration target disposed relative to the neutron source and the at least one gamma ray detector.

In another embodiment, the invention includes a method for calibrating a gamma ray detector onboard a downhole tool including a neutron source, the method including: detecting a plurality of characteristic gamma photons emitted from an energy calibration target; and calibrating the at least one gamma ray detector according to at least one known energy for the characteristic gamma photons.

In a further embodiment, the invention includes a computer program product stored on computer readable media and including computer executable instructions for calibrating a radiation detector, the instructions including instructions for: receiving spectral data from a radiation detector, the data including data associated with detection of a plurality of gamma photons induced in an energy calibration target by a neutron source; associating at least one spectral peak with a known gamma energy; and adjusting the radiation detector to correlate the spectral peak with the known gamma energy.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates an exemplary embodiment of a drill string that includes a logging instrument;

FIG. 2 illustrates an exemplary embodiment for well logging with an instrument deployed by a wireline;

FIG. 3 depicts aspects of a well logging instrument that includes a pulsed neutron source and a plurality of spectral detectors; and

FIGS. 4A and 4B, collectively referred to herein as FIG. 4, illustrate gamma spectra for a first spectral detector and a second spectral detector.

### DETAILED DESCRIPTION OF THE INVENTION

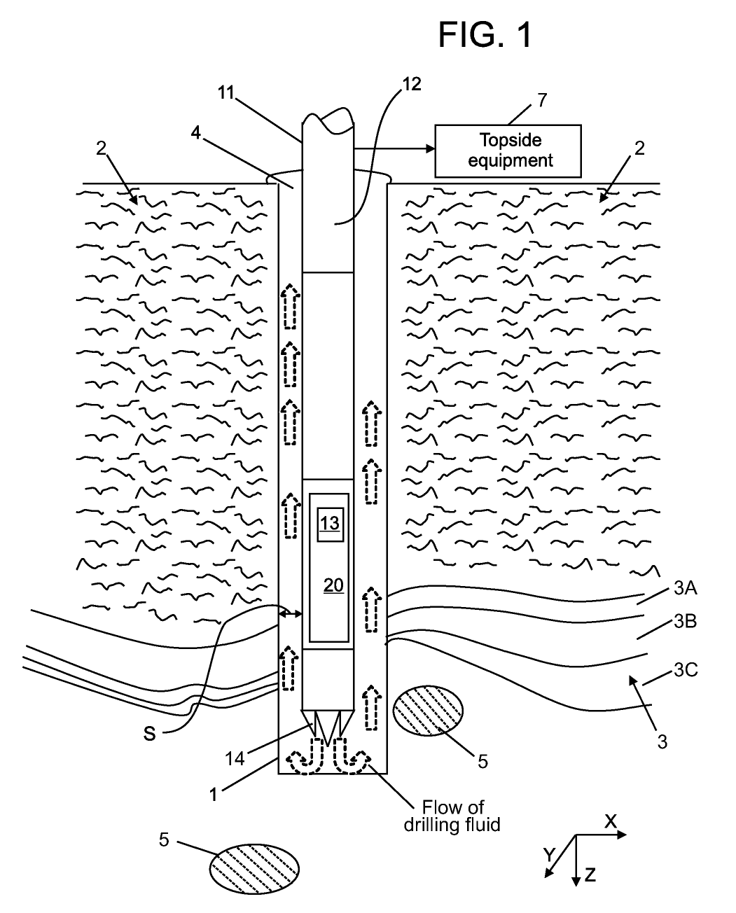

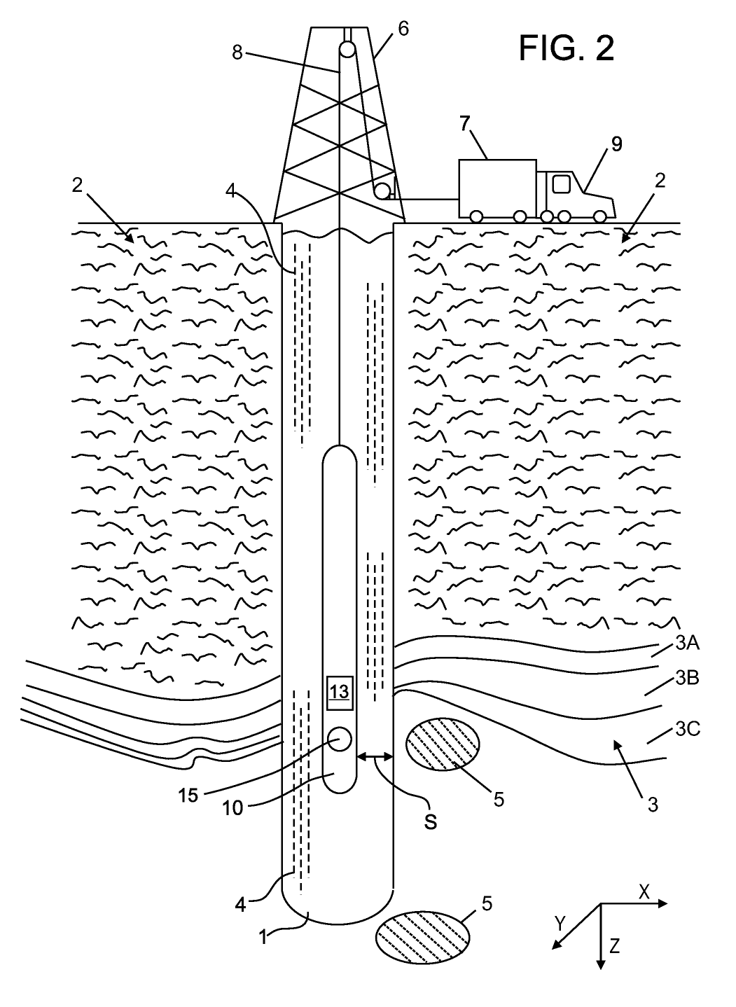

Disclosed are methods, apparatus and compositions for providing structural materials in a downhole instrument, where the materials also provide effective neutron shielding. For perspective, aspects of equipment where the materials may be used are presented in FIGS. 1 and 2.

Refer now to FIG. 1 where aspects of an apparatus for drilling a wellbore 1 (also referred to as a “borehole”) are shown. As a matter of convention, a depth of the wellbore 1 is described along a Z-axis, while a cross-section is provided on a plane described by an X-axis and a Y-axis.

In this example, the wellbore 1 is drilled into the Earth 2 using a drill string 11 driven by a drilling rig (not shown) which, among other things, provides rotational energy and downward force. The wellbore 1 generally traverses sub-surface materials, which may include various formations 3 (shown as formations 3A, 3B, 3C). One skilled in the art will recognize that the various geologic features as may be encountered in a subsurface environment may be referred to as “formations,” and that the array of materials down the borehole (i.e., downhole) may be referred to as “sub-surface materials.” That is, the formations 3 are formed of sub-surface materials. Accordingly, as used herein, it should be considered that while the term “formation” generally refers to geologic formations, and “sub-surface material,” includes any materials, and may include materials such as fluids, gases, liquids, and the like.

The drill string 11 includes lengths of drill pipe 12 which drive a drill bit 14. In this example, the drill bit 14 also provides a flow of a drilling fluid 4, such as drilling mud. The drilling fluid 4 is often pumped to the drill bit 14 through the drill pipe 12, where the fluid exits into the wellbore 1. This results in an upward flow of drilling fluid 4 within the wellbore 1. The upward flow generally cools the drill string 11 and components thereof, carries away cuttings from the drill bit 14 and prevents blowout of pressurized hydrocarbons 5.

The drilling fluid 4 (also referred to as “drilling mud”) generally includes a mixture of liquids such as water, drilling fluid, mud, oil, gases, and formation fluids as may be indigenous to the surroundings. Although drilling fluid 4 may be introduced for drilling operations, use or the presence of the drilling fluid 4 is neither required for nor necessarily excluded from well logging operations. Generally, a layer of materials will exist between an outer surface of the drill string 11 and a wall of the wellbore 1. This layer is referred to as a “standoff layer,” and includes a thickness, referred to as “standoff, S.”

The drill string 11 generally includes equipment for performing “measuring while drilling” (MWD), also referred to as “logging while drilling” (LWD). Performing MWD or LWD generally calls for operation of a logging instrument 20 that in incorporated into the drill string 11 and designed for operation while drilling. Generally, the MWD logging instrument 20 is coupled to an electronics package which is also on board the drill string 11, and therefore referred to as “downhole electronics 13.” Generally, the downhole electronics 13 provides for at least one of operational control and data analysis. Often, the MWD logging instrument 20 and the downhole electronics 13 are coupled to topside equipment 7. The topside equipment 7 may be included to further control operations, provide greater analysis capabilities as well as data logging and the like. A communications channel (not shown) may provide for communications to the topside equipment 7, and may operate via pulsed mud, wired pipe, and other technologies as are known in the art.

Generally, data from the MWD apparatus provide users with enhanced capabilities. For example, data made available from MWD evolutions may be useful as inputs to geosteering of the drill string 11 and the like.

Referring now to FIG. 2, an exemplary well logging instrument 10 (also referred to as a “tool”) for wireline logging is shown disposed in a wellbore 1 (also referred to as a “borehole”). As a matter of convention, a depth of the wellbore 1 is described along a Z-axis, while a cross-section is provided on a plane described by an X-axis and a Y-axis. Prior to well logging with the logging instrument 10, the wellbore 1 is drilled into the Earth 2 using a drilling rig, such as one shown in FIG. 1.

In some embodiments, the wellbore 1 has been filled, at least to some extent, with drilling fluid 4. The drilling fluid 4 (also referred to as “drilling mud”) generally includes a mixture of liquids such as water, drilling fluid, mud, oil, gases, and formation fluids as may be indigenous to the surroundings. Although drilling fluid 4 may be introduced for drilling operations, use or the presence of the drilling fluid 4 is neither required for nor necessarily excluded from well logging operations. Generally, a layer of materials will exist between an outer surface of the logging instrument 10 and a wall of the wellbore 1. This layer is referred to as a “standoff layer,” and includes a thickness, referred to as “standoff, S.”

The logging instrument 10 is lowered into the wellbore 1 using a wireline 8 deployed by a derrick 6 or similar equipment. Generally, the wireline 8 includes suspension apparatus, such as a load bearing cable, as well as other apparatus. The other apparatus may include a power supply, a communications link (such as wired or optical) and other such equipment. Generally, the wireline 8 is conveyed from a service truck 9 or other similar apparatus (such as a service station, a base station, etc, . . . ). Often, the wireline 8 is coupled to topside equipment 7. The topside equipment 7 may provide power to the logging instrument 10, as well as provide computing and processing capabilities for at least one of control of operations and analysis of data.

Generally, the logging instrument 10 includes apparatus for performing measurements “downhole” or in the wellbore 1. Such apparatus include, for example, a variety of sensors 15. Exemplary sensors 15 may include radiation detectors. The sensors may communicate with downhole electronics 13. The measurements and other sequences as may be performed using the logging instrument 10 are generally performed to ascertain and qualify a presence of hydrocarbons 5.

Before aspects of the invention are discussed in greater detail, certain additional definitions are provided.

As used herein, the term “gamma radiation detector,” “radiation detector” and other related terms generally reference instruments that measure the gamma radiation entering the instrument 10, 20. For example, the gamma radiation detector may use a scintillator material that interacts with gamma radiation and produces light photons which are in turn detected by a photomultiplier tube coupled to electronics. Exemplary gamma radiation detectors include, without limitation, sodium iodide (NaI), lanthanum bromides (LaBr), cesium iodide (CsI), bismuth germinate (BGO), thallium iodide (TlI), and other organic crystals, inorganic crystals, plastics, solid state detectors, and combinations thereof.

Also as used herein, the term “characterization data” generally makes reference to a radiological profile (e.g., a gamma emission profile) of the instrument. More specifically, the instrument will exhibit certain radiological characteristics. In various embodiments, these characteristics are a result of irradiation with neutrons, and activation of components of the instrument which may ultimately result in emission of gamma rays from the components. Non-limiting embodiments for the generation of characterization data are provided herein.

The term “detector geometry” relates to a configuration of the gamma radiation detector(s). The detector geometry may include a size and a shape of the scintillator material and photomultiplier or other type of detector. The term “placement geometry” relates to relative placement of a gamma radiation detector within the logging instrument or in relation to the surrounding volume. The term “logging while drilling” (LWD) relates to measuring parameters from the wellbore 1 while drilling is taking place.

The terms “neutron capture” or “capture” make reference to a kind of nuclear interaction in which a neutron collides with an atomic nucleus and is merged into the nucleus, thus forming a heavier nucleus. As a result, the heavier nucleus enters into a higher energy state. At least some of the energy of the neutron capture interaction is usually lost by emission of gamma rays. Generally, the neutrons are produced with a pulsed neutron source.

While operating in the subsurface environment, the electronically timed pulsed-neutron source emits neutrons having energy of about 14 MeV. The neutrons are emitted into the ambient formation(s) 4 and the subsurface materials. In about 1-2 μsecs, these fast neutrons promptly interact with the nuclei of the surrounding sub-surface materials and scatter elastically as well as inelastically, ultimately losing their energy. Some of the nuclei of the atoms with which the neutrons interact become energetically excited during the inelastic scattering process, after which they return to the ground state by emitting one or more gamma rays with energies characteristic of the parent isotope. This process results in the measured inelastic spectrum of gamma ray energies, and can only take place if the energy of the incident neutron is sufficient to raise the nucleus of the parent isotope to one or more of its excited energy levels, or bound states.

The neutrons continue their slowing down process until they reach thermal equilibrium with the surrounding medium. Thermal neutrons typically possess energy of about 0.025 eV, and may remain in a diffusion process for up to about 1,000 μsec, or slightly more, before being absorbed by the nuclei of the surrounding atoms. This absorption results in new isotopes of the same elements. Upon absorption, the nuclei of these isotopes usually de-excite through emission of one or more gamma rays. As in the case of the inelastic spectrum, these energies carry the fingerprint of the parent isotope and allow each element (i.e., isotope) to be uniquely identified. This absorption process leads to the acquisition of the capture spectrum. The capture spectra and the inelastic spectra for each individual isotope are different.

Embodiments of downhole tools using a pulsed neutron generator usually provide a burst of about 10E4-10E5 fast neutrons. When the neutron flux is averaged over time, this is equivalent to a steady state emission of about 10E8 neutrons/second. For these embodiments, an energy spectrum of the neutrons shows that the neutrons are very close to monoenergetic, and exhibit an initial energy of about 14.2 MeV, while an angular distribution of the neutrons is very close to isotropic. Therefore, neutrons provided by a pulsed neutron generator generally radiate in all directions, and penetrate not only into the formation direction but also into the tool itself. Accordingly, most tools making use of neutron sources include significant shielding for protection of other components.

The terms “inelastic collision,” “neutron inelastic scattering” or “inelastic” make reference to a collision in which an incoming neutron interacts with a target nucleus and causes the nucleus to become excited, thereby releasing a gamma ray before returning to the ground state. In inelastic collisions, the incoming neutron is not merged into the target nucleus, but transfers some of its energy to the target nucleus before that energy is released in the form of a gamma ray.

Various types of interactions involve either absorption or emission of gamma radiation. Predominant types (as a function of increasing energy) include photoelectric effect, Compton scattering and pair production. As a matter of convention, “photoelectric effect” relates to interactions where electrons are emitted from matter after the absorption of a gamma ray. The emitted electrons may be referred to as “photoelectrons.” The photoelectric effect may occur with photons having energy of about a few eV or higher. If a photon has sufficiently high energy, Compton scattering or pair production may occur. Generally, Compton scattering relates to a decrease in energy (increase in wavelength) of a gamma ray photon when the photon interacts with matter. In pair production, higher energy photons may interact with a target and cause an electron and a positron pair to be formed.

Further, it should be noted that a variety of neutron emitting sources are known. Examples include americium-beryllium (AmBe) sources, plutonium-beryllium (PuBe) sources, californium sources (e.g., Cf-252) and others. Therefore, while the teachings herein are generally directed to a pulsed neutron source, it should be recognized that the term “neutron emitting,” “neutron generator,” and the like may be considered with reference to the variety of sources now available or subsequently devised for providing neutrons downhole. The term “thermalize” generally relates a process for reducing the kinetic energy of a neutron to a thermal energy of about 0.025 eV.

As discussed herein, detection of gamma photons may be sorted by a number of detection events according to energy. Accordingly, a distinct or distinguishable grouping of detection events may be referred to by terms such as a “line,” a “peak” and by other such terms as are known in the art. It is recognized that such energy groups may not actually appear as a “line” on an spectral graph. That is, it is recognized that, for example, energy groupings are not always distinct, such as when considering one type of radiation detector in comparison to another. Accordingly, interpretation of the presence of an energy group is subject to various techniques for qualifying spectral data. As interpretation of spectral data is generally known in the art, this aspect is not discussed in greater detail herein, however, it should be recognized that aspects of spectral analysis may involve complicated and even subjective interpretation.

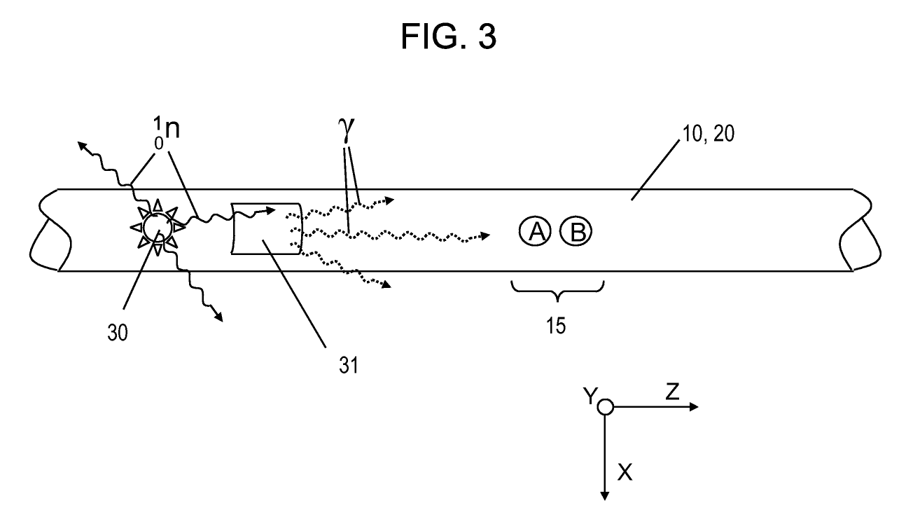

Turning now to FIG. 3, aspects of a logging instrument 10, 20 according to the present invention are shown. In this example, the logging instrument 10, 20 includes a pulsed neutron source 30, an energy calibration target 31 and a plurality of radiation detectors as the sensors 15. The radiation detectors 15 are capable of resolving gamma energy for incident photons.

In operation, the neutron source 30 provides high energy neutrons (of about 14 MeV, as discussed above). A fraction of the neutrons that are incident on the energy calibration target 31 interact therein, and induce a gamma ray. In this embodiment, the energy calibration target 31 is fabricated from lead (Pb). Accordingly, the induced gamma exhibits an energy of about 2,615 keV. A fraction of the induced gamma rays are then detected in the first detector (shown here as Detector A). An even smaller fraction of the induced gamma rays may also be detected in other detectors arranged proximate to the first detector (a second detector shown here as Detector B).

The energy calibration target 31 may be fabricated from other suitable materials, or combinations of materials. Accordingly, the energy calibration target 31 may produce at least one energy line (such as the 2,615 keV gamma emission). Generally, materials selected for incorporation into the energy calibration target 31 are selected to provide relatively distinct gamma emission that are expected to be separate from emissions of interest when considering activation or interactions in the sub-surface materials.

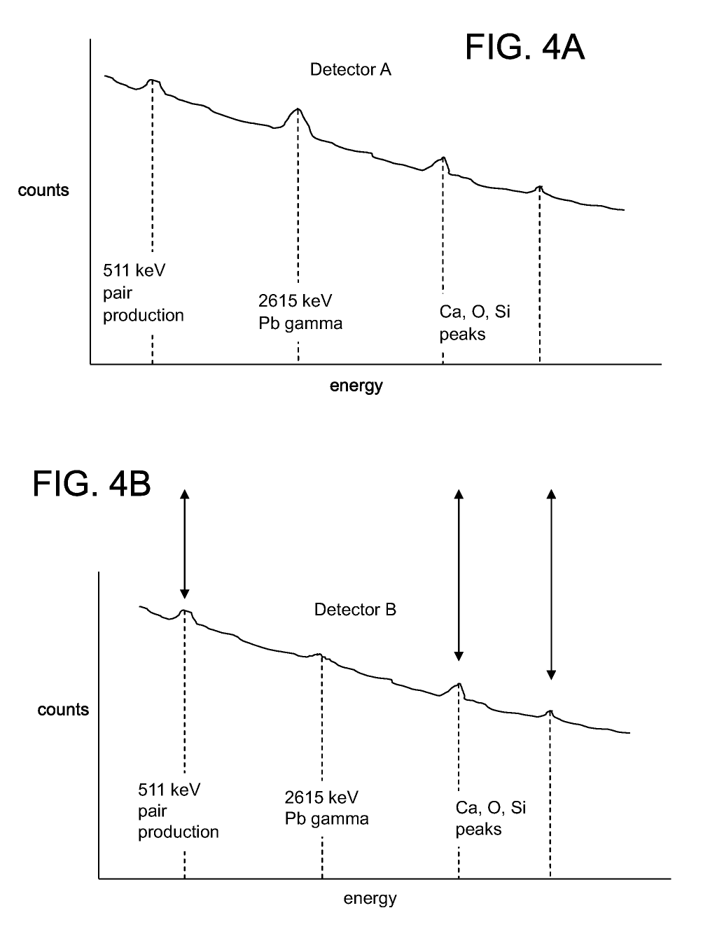

Turning now to FIG. 4, it may be seen that the spectrum collected from the first detector 15 includes a gamma emission from the energy calibration target 31. Using at least this line, gain adjustments may be performed such that the gamma emission is properly identified by users as having an characteristic energy (in this case, 2,615 keV). As the second detector (Detector B) has a placement geometry that is proximate to Detector A, users may then adjust the gain to properly correlate other spectral peaks. This may be seen with reference to FIGS. 4A and 4B, together, where peaks for pair production, calcium (Ca), oxygen (O), and silicon (Si) are shown. In this manner, energy calibration of a first detector may be propagated throughout the remaining radiation detectors 15.

Energy calibrations may be performed using techniques as are known in the art. For example, use of a single energy line may provide for direct adjustment. Use of multiple energy lines may provide for more comprehensive calibration sequences. As such, curve fitting of calibration data may be performed.

Having thus described certain aspects of the invention, additional benefits and features are now discussed. By making use of the energy calibration target provided herein, users are provided with a downhole tool 10, 20 that does not require presence of additional radioactive material. Advantageously, energy calibration may be completed downhole, and on an ongoing basis. That is, in some embodiments, at least one of the downhole electronics 13 and the topside electronics 7 may monitor energies associated with the energy calibration target 31 (in this case, 2,615 keV) and make needed adjustments to ensure collection of accurate data. The adjusting may be performed on a real time basis, a near real time basis, or periodically as determined appropriate.

In summary, the teachings herein provide for reliable energy calibration of gamma detection instrumentation in downhole tools that include a neutron source. Advantageously, users may dispense with the incorporation of additional radioactive material traditionally maintained in such tooling.

In support of the teachings herein, various analysis components may be used, including a digital system and/or an analog system. The system(s) may have components such as a processor, FPGA, storage media, memory, input, output, communications link (wired, wireless, pulsed mud, optical or other), user interfaces, software and firmware programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An instrument for performing measurements downhole, the instrument comprising:
a neutron source;
at least one gamma ray detector equipped for discriminating an energy of an incident gamma photon; and
an energy calibration target disposed relative to the neutron source and the at least one gamma ray detector.

2. The instrument as in claim 1, wherein the neutron source comprises at least one of a pulsed neutron generator, a Cf source, an AmBe source, and an PuBe source.

3. The instrument as in claim 1, wherein the energy calibration target comprises at least one of a lead target and another material rarely encountered in a downhole environment.

4. The instrument as in claim 1, wherein the energy calibration target comprises a plurality of materials.

5. The instrument as in claim 4, wherein the plurality of materials are selected for providing a plurality of energy lines for energy calibration of the at least one gamma ray detector.

6. A method for calibrating a gamma ray detector onboard a downhole tool comprising a neutron source, the method comprising:
detecting a plurality of characteristic gamma photons emitted from an energy calibration target; and
detecting a plurality of characteristic gamma photons emitted from the instrument and downhole environment; and
calibrating the at least one gamma ray detector according to at least one known energy for the characteristic gamma photons.

7. The method as in claim 6, wherein the calibrating comprises adjusting a gain for the at least one detector.

8. The method as in claim 7, wherein the adjusting is performed on a basis that is one of real time, near real time, and periodically.

9. The method as in claim 6, wherein the calibrating further comprises performing curve fitting for more than one known energy.

10. The method as in claim 6, further comprising calibrating another radiation detector proximate to the radiation detector by correlating spectral data.

11. The method as in claim 10, wherein the spectral data comprises a spectral peak for at least one of pair production, positron annihilation, calcium, oxygen and silicon.

12. A computer program product stored on computer readable media and comprising computer executable instructions for calibrating a radiation detector, the instructions comprising instructions for:
receiving spectral data from a radiation detector, the data including data associated with detection of a plurality of gamma photons induced in an energy calibration target and surrounding materials by a neutron source;
associating at least one spectral peak with a known gamma energy; and
adjusting the radiation detector to correlate the spectral peak with the known gamma energy.

13. The computer program product as in claim 12, further comprising instructions for:
comparing at least one spectral peak from another radiation detector to spectral data from the radiation detector; and
adjusting the another radiation detector to correlate an energy of the at least one spectral peak with the spectral data of the radiation detector.

14. The computer program product as in claim 12, wherein associating further comprises instructions for performing curve fitting of a plurality of spectral peaks.
